(19) United States
(12) Patent Application Publication
(10) Pub. No.: US 2019/0327038 A1
(43) Pub. Date: Oct. 24, 2019

(54) Data Transmission Method and Apparatus

(71) Applicant: Huawei Technologies Co., Ltd., Shenzhen (CN)

(72) Inventors: Bai Du, Shanghai (CN); Peng Zhang, Shanghai (CN)

(21) Appl. No.: 16/502,334

(22) Filed: Jul. 3, 2019

Related U.S. Application Data
(63) Continuation of application No. PCT/CN2018/071368, filed on Jan. 4, 2018.

(30) Foreign Application Priority Data
Jan. 6, 2017 (CN) 201710010425.4

(51) Int. Cl. H04L 5/00; H04W 72/04; H04L 1/16

(52) U.S. Cl. CPC H04L 5/0005; H04L 5/0041; H04L 1/1607; H04W 72/0446; H04L 5/0055; H04L 5/0046

(57) ABSTRACT

A data transmission method and a data transmission apparatus are disclosed. In an embodiment an apparatus includes a processor and a non-transitory memory storing programming for execution by the processor, the programming including instructions for receiving data from a second device, wherein the data is carried on time-frequency resources, receiving indication information from the second device, dividing the time-frequency resources into a first time-frequency resource and/or a second time-frequency resource according to the indication information and determining a manner of sending feedback information of data carried on the first time-frequency resource and/or a manner of sending feedback information of data carried on the second time-frequency resource to the second device.

### CROSS-REFERENCE TO RELATED APPLICATIONS

This application is a continuation of International Application No. PCT/CN2018/071368, filed on Jan. 4, 2018, which claims priority to Chinese Patent Application No. 201710010425.4, filed on Jan. 6, 2017. The disclosures of the aforementioned applications are hereby incorporated by reference in their entireties.

### TECHNICAL FIELD

The present invention relates to the field of communications technologies, and in particular, to a data transmission method and apparatus.

### BACKGROUND

In a long term evolution (LTE) system, to-be-transmitted information is segmented in a form of a transport block (TB) based on an actual requirement, a cyclic redundancy check (CRC) bit of each transport block is attached to the transport block, and one TB is sent at each transmission time interval (TTI). A transport block to which a CRC is attached is usually split into a plurality of code blocks (CB) due to limitation of a coding length, and after CRC insertion, channel coding, and rate matching are performed on the CBs, referring to FIG. 1, an obtained data code stream is referred to as a codeword.

In the prior art, a TB transmitted by a transmit end is finally mapped to a codeword, and a receive end sends feedback information to the transmit end based on a decoding status of all data in the codeword. When some data in the codeword is punctured, feedback overheads of the receive end are relatively large and feedback efficiency is low.

### SUMMARY

To solve the foregoing technical problem, the present invention provides a data transmission method and apparatus. When some data is punctured, feedback is performed only on some data based on indication information, to reduce feedback overheads and improve feedback efficiency.

According to a first aspect, a data transmission method is provided, and the method includes: receiving, by a first device, data from a second device, where the data is carried on time-frequency resources; receiving, by the first device, indication information from the second device, where the indication information is used by the first device to divide the time-frequency resources into a first time-frequency resource and/or a second time-frequency resource; and determining, by the first device, a manner of sending, to the second device, feedback information of data carried on the first time-frequency resource and/or a manner of sending, to the second device, feedback information of data carried on the second time-frequency resource. In this way, feedback overheads are reduced.

In a possible implementation, the indication information includes at least one of scheduling unit identification information, CB identification information, and CB group identification information; or location information of a punctured area.

In a possible implementation, when the indication information is the location information of the punctured area, the first device calculates the first time-frequency resource based on the location information of the punctured area, and a time-frequency resource, in the time-frequency resources, other than the first time-frequency resource is the second time-frequency resource.

In a possible implementation, when there is an intersection between at least one scheduling unit and the punctured area, the at least one scheduling unit belongs to the first time-frequency resource; or when there is an intersection between a time-frequency resource of at least one CB and the punctured area, the at least one CB belongs to the first time-frequency resource; or when there is an intersection between a time-frequency resource of at least one CB group and the punctured area, the at least one CB group belongs to the first time-frequency resource.

In a possible implementation, after the determining, by the first device, a manner of sending, to the second device, feedback information of data carried on the first time-frequency resource and a manner of sending, to the second device, feedback information of data carried on the second time-frequency resource, the method further includes: skipping, by the first device, sending, to the second device, the feedback information of the data carried on the first time-frequency resource.

In a possible implementation, after the determining, by the first device, a manner of sending, to the second device, feedback information of data carried on the first time-frequency resource and a manner of sending, to the second device, feedback information of data carried on the second time-frequency resource, the method further includes:

sending, by the first device to the second device, feedback information of a first CB in the data carried on the first time-frequency resource, where the first device determines the first CB according to a preset rule, and the first CB is a part or all of the data on the first time-frequency resource.

In a possible implementation, after the determining, by the first device, a manner of sending, to the second device, feedback information of data carried on the first time-frequency resource and a manner of sending, to the second device, feedback information of data carried on the second time-frequency resource, the method further includes:

sending, by the first device to the second device, the feedback information of the data carried on the second time-frequency resource. With reference to the first aspect, in a possible implementation of the first aspect, when the first device does not send, to the second device, the feedback information of the data carried on the first time-frequency resource, and the first device sends, to the second device, the feedback information of the data carried on the second time-frequency resource, the first device sends a decoding status of a CB on the second time-frequency resource to the second device, and the first device sends an acknowledgement to the second device if all the CB is correctly decoded, or the first device sends a negative acknowledgement to the second device if at least one of the CB is incorrectly decoded; or

the first device sends a decoding status of a CB on the second time-frequency resource to the second device, and the first device sends an acknowledgement to the second device for a CB that is correctly decoded, or the first device sends a negative acknowledgement to the second device for a CB that is incorrectly decoded.

In a possible implementation, when the first device does not send, to the second device, the feedback information of the data carried on the first time-frequency resource, and the first device sends, to the second device, the feedback information of the data carried on the second time-frequency resource, the first device sends a decoding status of a CB group on the second time-frequency resource to the second device, and the first device sends an acknowledgement to the second device if all the CB group is correctly decoded, or the first device sends a negative acknowledgement to the second device if at least one of the CB group is incorrectly decoded; or

the first device sends a decoding status of a CB group on the second time-frequency resource to the second device, and the first device sends an acknowledgement to the second device for a CB group that is correctly decoded, or the first device sends a negative acknowledgement to the second device for a CB group that is incorrectly decoded.

In a possible implementation, when the first device sends, to the second device, the feedback information of the first CB in the data carried on the first time-frequency resource, and the first device sends, to the second device, the feedback information of the data carried on the second time-frequency resource, the first device sends decoding statuses of a CB on the second time-frequency resource and the first CB to the second device, and the first device sends an acknowledgement to the second device if all the CB on the second time-frequency resource and the first CB are correctly decoded, or the first device sends a negative acknowledgement to the second device if at least one of the CB on the second time-frequency resource and the first CB is incorrectly decoded; or

the first device sends decoding statuses of a CB on the second time-frequency resource and the first CB to the second device, and the first device sends an acknowledgement to the second device if the first CB is correctly decoded, the first device sends a negative acknowledgement to the second device if the first CB is incorrectly decoded, the first device sends an acknowledgement to the second device if all the CB on the second time-frequency resource is correctly decoded, or the first device sends a negative acknowledgement to the second device if at least one of the CB on the second time-frequency resource is incorrectly decoded; or

the first device sends decoding statuses of a CB on the second time-frequency resource and the first CB to the second device, and the first device sends an acknowledgement to the second device for a CB that is correctly decoded in the CB on the second time-frequency resource and the first CB, or the first device sends a negative acknowledgement to the second device for a CB that is incorrectly decoded in the CB on the second time-frequency resource and the first CB.

According to a second aspect, a data transmission method is provided, and the method includes: sending, by a second device, data to a first device, where the data is carried on time-frequency resources; and sending, by the second device, indication information to the first device, where the indication information is used by the first device to divide the time-frequency resources into a first time-frequency resource and/or a second time-frequency resource, and to determine a manner of sending, to the second device, feedback information of data carried on the first time-frequency resource and/or a manner of sending, to the second device, feedback information of data carried on the second time-frequency resource. In this way, feedback overheads are reduced.

In a possible implementation, the indication information includes at least one of scheduling unit identification information, code block CB identification information, and CB group identification information; or location information of a punctured area.

In a possible implementation, when the indication information is the location information of the punctured area, the first device calculates the first time-frequency resource based on the location information of the punctured area, and a time-frequency resource, in the time-frequency resources, other than the first time-frequency resource is the second time-frequency resource.

In a possible implementation, when there is an intersection between at least one scheduling unit and the punctured area, the at least one scheduling unit belongs to the first time-frequency resource; or when there is an intersection between a time-frequency resource of at least one CB and the punctured area, the at least one CB belongs to the first time-frequency resource; or when there is an intersection between a time-frequency resource of at least one CB group and the punctured area, the at least one CB group belongs to the first time-frequency resource.

In a possible implementation, after the first device determines the manner of sending, to the second device, the feedback information of the data carried on the first time-frequency resource and the manner of sending the feedback information of the data carried on the second time-frequency resource, the method further includes: skipping, by the second device, receiving, from the first device, the feedback information of the data carried on the first time-frequency resource.

In a possible implementation, after the first device determines the manner of sending, to the second device, the feedback information of the data carried on the first time-frequency resource and the manner of sending the feedback information of the data carried on the second time-frequency resource, the method further includes: receiving, by the second device from the first device, feedback information of a first CB in the data carried on the first time-frequency resource, where the first device determines the first CB according to a preset rule, and the first CB is a part or all of the data on the first time-frequency resource.

In a possible implementation, after the first device determines the manner of sending, to the second device, the feedback information of the data carried on the first time-frequency resource and the manner of sending the feedback information of the data carried on the second time-frequency resource, the method further includes: receiving, by the second device, the feedback information of the data on the second time-frequency resource from the first device.

In a possible implementation, when the second device does not receive, from the first device, the feedback information of the data carried on the first time-frequency resource, and the second device receives the feedback information of the data on the second time-frequency resource from the first device, the second device receives a decoding status of a CB on the second time-frequency resource from the first device, and the second device receives an acknowledgement from the first device if all the CB is correctly decoded, or the second device receives a negative acknowledgement from the first device if at least one of the CB is incorrectly decoded; or

the second device receives a decoding status of a CB on the second time-frequency resource from the first device, and the second device receives an acknowledgement from the first device for a CB that is correctly decoded, or the second device receives a negative acknowledgement from the first device for a CB that is incorrectly decoded.

In a possible implementation, when the second device does not receive, from the first device, the feedback information of the data carried on the first time-frequency resource, and the second device receives the feedback information of the data on the second time-frequency resource from the first device, the second device receives a decoding status of a CB group on the second time-frequency resource from the first device, and the second device receives an acknowledgement from the first device if all the CB group is correctly decoded, or the second device receives a negative acknowledgement from the first device if at least one of the CB group is incorrectly decoded; or the second device receives a decoding status of a CB group on the second time-frequency resource from the first device, and the second device receives an acknowledgement from the first device for a CB group that is correctly decoded, or the second device receives a negative acknowledgement from the first device for a CB group that is incorrectly decoded.

In a possible implementation, when the second device receives, from the first device, the feedback information of the first CB in the data carried on the first time-frequency resource, and the second device receives the feedback information of the data on the second time-frequency resource from the first device, the second device receives decoding statuses of a CB on the second time-frequency resource and the first CB from the first device, and the second device receives an acknowledgement from the first device if all the CB on the second time-frequency resource and the first CB are correctly decoded, or the second device receives a negative acknowledgement from the first device if at least one of the CB on the second time-frequency resource and the first CB is incorrectly decoded; or

the second device receives decoding statuses of a CB on the second time-frequency resource and the first CB from the first device, and the second device receives an acknowledgement from the first device if the first CB is correctly decoded, the second device receives a negative acknowledgement from the first device if the first CB is incorrectly decoded, the second device receives an acknowledgement from the first device if all the CB on the second time-frequency resource is correctly decoded, or the second device receives a negative acknowledgement from the first device if at least one of the CB on the second time-frequency resource is incorrectly decoded; or

the second device receives decoding statuses of a CB on the second time-frequency resource and the first CB from the first device, and the second device receives an acknowledgement from the first device for a CB that is correctly decoded in the CB on the second time-frequency resource and the first CB, or the second device receives a negative acknowledgement from the first device for a CB that is incorrectly decoded in the CB on the second time-frequency resource and the first CB.

According to a third aspect, a data transmission apparatus is provided, including a first receiving unit, a second receiving unit, and a determining unit, to perform the method in the first aspect or any possible implementation of the first aspect.

According to a fourth aspect, a data transmission apparatus is provided, including a first sending unit and a second sending unit, to perform the method in the second aspect or any possible implementation of the second aspect.

According to a fifth aspect, a communications apparatus is provided, including a processor, a memory, a receiver, and a transmitter, to perform the method in the first aspect or any possible implementation of the first aspect.

According to a sixth aspect, a communications apparatus is provided, including a processor, a memory, a receiver, and a transmitter, to perform the method in the second aspect or any possible implementation of the second aspect.

### BRIEF DESCRIPTION OF THE DRAWINGS

FIG. 1 is a schematic diagram of block interleaving and rate matching in the prior art;

FIG. 2 is a schematic diagram of a system architecture according to an embodiment of the present invention;

FIG. 3 shows an example of a schematic flowchart corresponding to a data transmission method according to Embodiment 1 of the present invention;

FIG. 4 is a schematic diagram of preempting eMBB data by URLLC data;

FIG. 5a is a schematic diagram of puncturing scheduling units according to Embodiment 1 of the present invention;

FIG. 5b is another schematic diagram of puncturing scheduling units according to Embodiment 1 of the present invention;

FIG. 5c is still another schematic diagram of puncturing scheduling units according to Embodiment 1 of the present invention;

FIG. 5d is yet another schematic diagram of puncturing scheduling units according to Embodiment 1 of the present invention;

FIG. 5e is still yet another schematic diagram of puncturing scheduling units according to Embodiment 1 of the present invention;

FIG. 6a is a schematic diagram of puncturing a slot 2 according to Embodiment 1 of the present invention;

FIG. 6b is a schematic diagram of a CB in a slot 2 according to Embodiment 1 of the present invention;

FIG. 6c is another schematic diagram of a CB in a slot 2 according to Embodiment 1 of the present invention;

FIG. 6d is still another schematic diagram of a CB in a slot 2 according to Embodiment 1 of the present invention;

FIG. 6e is a schematic diagram of puncturing a slot 1 and a slot 2 according to Embodiment 1 of the present invention;

FIG. 7 is a schematic diagram of puncturing statuses of CBs according to Embodiment 2 of the present invention;

FIG. 8 is a schematic diagram of puncturing statuses of CB groups according to Embodiment 3 of the present invention;

FIG. 9 is a schematic structural diagram of a data transmission apparatus according to Embodiment 6 of the present invention;

FIG. 10 is a schematic structural diagram of a data transmission apparatus according to Embodiment 7 of the present invention;

FIG. 11 is a schematic structural diagram of a communications apparatus according to Embodiment 8 of the present invention; and

FIG. 12 is a schematic structural diagram of a communications apparatus according to Embodiment 9 of the present invention.

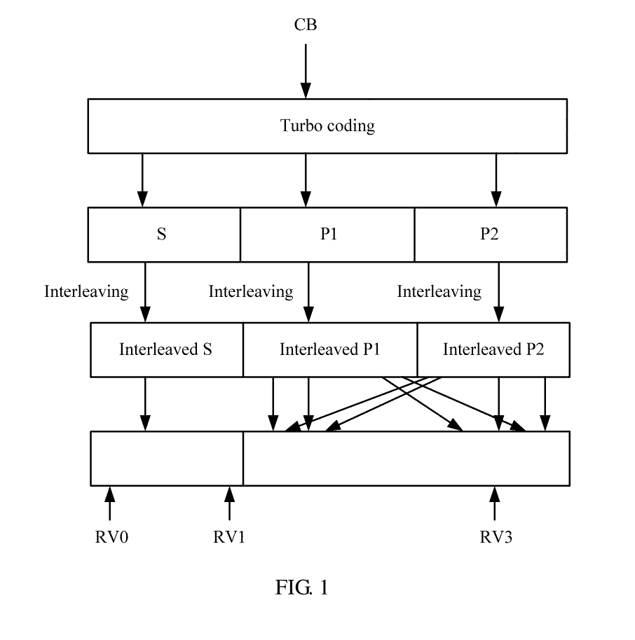

### DETAILED DESCRIPTION OF ILLUSTRATIVE EMBODIMENTS

To make the objectives, technical solutions, and advantages of the present invention clearer, the following further describes the present invention in detail with reference to the accompanying drawings. Apparently, the described embodiments are merely some rather than all of the embodiments of the present invention.

In the specification, claims, and accompanying drawings of this application, the terms “first”, “second”, and the like are intended to distinguish between different objects but do not indicate a particular order. In addition, the terms “comprising”, “including”, or any other variant thereof, are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

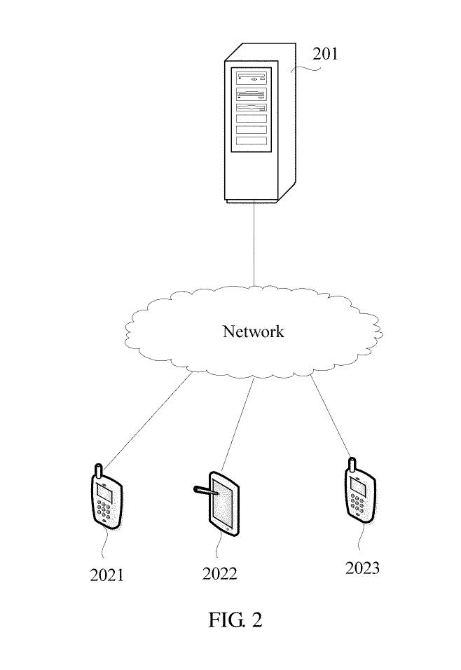

A data transmission method in an embodiment of the present invention may be applied to a plurality of system architectures. FIG. 2 is a schematic diagram of a system architecture to which an embodiment of the present invention is applicable. As shown in FIG. 2, the system architecture includes a network device 201 and one or more terminals, such as a first terminal 2021, a second terminal 2022, and a third terminal 2023 shown in FIG. 2. The network device 201 may transmit information with the first terminal 2021, the second terminal 2022, and the third terminal 2023 through a network. Further, the first terminal 2021, the second terminal 2022, and the third terminal 2023 may transmit information to each other.

In the embodiments of the present invention, the network device includes but is not limited to a NodeB, an evolved NodeB eNodeB, a base station in a fifth generation (5G) communications system, a base station in a future communications system, an access node in a Wi-Fi system, a wireless relay node, a wireless backhaul node, and user equipment (UE). The base station is an apparatus deployed in a radio access network to provide a wireless communication function. For example, a device that provides a base station function in a 2G network includes a base transceiver station (BTS) and a base station controller (BSC). A device that provides a base station function in a 3G network includes a NodeB (NodeB) and a radio network controller (RNC). A device that provides a base station function in a 4G network includes an evolved NodeB (evolved NodeB, eNB). A device that provides a base station function in a 5G network includes a New Radio NodeB (gNB), a centralized unit (CU), a distributed unit, and a New Radio controller. In a WLAN, a device that provides a base station function is an access point (AP).

The terminal may be a device (device) providing voice and/or data connectivity for a user, and may include a wireless terminal and a wired terminal. The wireless terminal may be a handheld device having a wireless connection function, or another processing device connected to a wireless modem. The terminal communicates with one or more core networks through a radio access network (RAN), or may access a distributed network in a self-organizing manner or a grant free manner, or may access a wireless network in another manner to perform communication. Alternatively, the terminal may perform wireless communication with another terminal, or the terminal may directly perform wireless communication with another terminal. For example, the terminal may be a mobile phone, a computer, a tablet computer, a personal digital assistant (PDA), a mobile Internet device (MID), a wearable device, and an e-book reader. For example, the wireless terminal may also be a portable, pocket-sized, handheld, computer built-in, or in-vehicle mobile device. For still another example, the wireless terminal may be a mobile station, an access point, or a part of UE.

A communications system to which the foregoing system architecture is applicable includes but is not limited to a code division multiple access (CDMA) IS-95 system, a code division multiple access (CDMA) 2000 system, a time division-synchronous code division multiple access (TD-SCDMA) system, a wideband code division multiple access (WCDMA) system, a time division duplexing-long term evolution (TDD LTE) system, a frequency division duplexing-long term evolution (FDD LTE) system, a long term evolution-advanced (LTE-advanced) system, and various future evolved wireless communications systems (such as a 5G system).

In an example of the 5G system (also known as the New Radio system), specifically, a new service type is defined in the 5G system: an ultra-reliable and low-latency communications (URLLC) service and an enhanced mobile broadband (eMBB) service. The URLLC service requires high reliability and a low latency, while the eMBB service primarily requires ensuring a peak rate. Therefore, the URLLC service tends to use scheduling time shorter than that of the eMBB service, and when the eMBB service is being transmitted, the URLLC service can directly replace some data sent by the eMBB service with data of the URLLC service for sending, resulting in an information transmission failure due to puncturing during information transmission.

For example, in a process in which the network device 201 sends, to the first terminal 2021, a TB used to transmit eMBB service data, if it is determined that the network device 201 needs to transmit URLLC service data to the first terminal 2021, the network device may puncture a plurality of CBs included in the TB, to be specific, replace some eMBB service data in the plurality of CBs with URLLC service data. In this way, after the first terminal 2021 receives the TB, the first terminal 2021 needs to feed back to the network device 201. If feedback is performed on all data according to the prior art, overheads are wasted and feedback efficiency is low.

Based on the foregoing system architecture, in an application scenario of the embodiments of the present invention, a first device is the network device 201, and a second device is any one of the first terminal 2021, the second terminal 2022, and the third terminal 2023. Alternatively, in another application scenario, a first device is any one of the first terminal 2021, the second terminal 2022, and the third terminal 2023, and a second device is the network device 201. Alternatively, in still another application scenario, a first device is any one of the first terminal 2021, the second terminal 2022, and the third terminal 2023, and a second device is a terminal, in the first terminal 2021, the second terminal 2022, and the third terminal 2023, other than the first device. In other words, the data transmission method in the embodiments of the present invention may be applied to uplink and downlink information transmission between a network device and a terminal, or may be applied to information transmission between different terminals. For downlink data transmission, the second device is a base station, and the corresponding first device is a terminal. For uplink data transmission, the second device is a terminal, and the corresponding first device is a base station. For D2D data transmission, the second device is UE, and the corresponding first device is also UE. This is not limited in the embodiments of this application.

A sending device and a receiving device in the embodiments of this application may be deployed on land and includes an indoor or outdoor device, a handheld device, or an in-vehicle device, or may be deployed on the water, or may be deployed on an airplane, a balloon, or a satellite in the air. The UE in the embodiments of this application may be a mobile phone, a tablet computer (Pad), a computer with a wireless transceiver function, a virtual reality (VR) terminal device, an augmented reality (AR) terminal device, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, or the like. An application scenario is not limited in the embodiments of this application.

### Embodiment 1

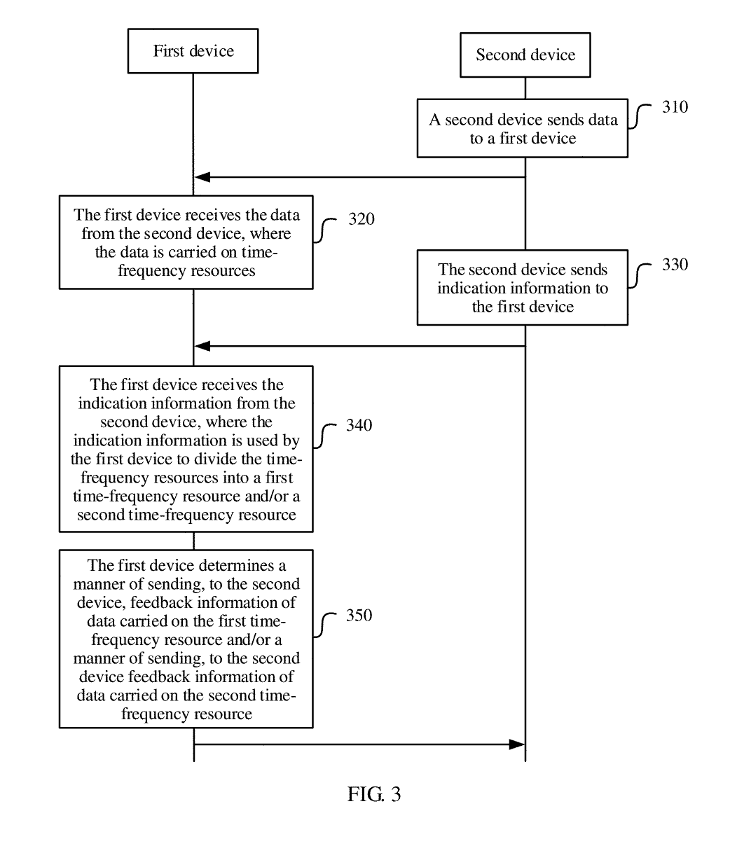

FIG. 3 shows an example of a schematic flowchart corresponding to a data transmission method according to Embodiment 1 of the present invention. As shown in FIG. 3, the method includes the following steps:

Step 310: A second device sends data to a first device, where the data is carried on time-frequency resources.

Step 320: The first device receives the data from the second device.

Step 330: The second device sends indication information to the first device.

Step 340: The first device receives the indication information from the first device, where the indication information is used by the first device to divide the time-frequency resources into a first time-frequency resource and/or a second time-frequency resource.

Step 350: The first device determines a manner of sending, to the second device, feedback information of data carried on the first time-frequency resource and/or a manner of sending, to the second device, feedback information of data carried on the second time-frequency resource.

It should be noted that sequence numbers of the steps are merely examples for describing an execution process. A specific sequence of the steps is not limited in this embodiment of the present invention, and some steps may be performed simultaneously or not performed according to the foregoing sequence numbers. For example, step 310 and step 330 may be simultaneously performed, or step 330 may be performed after step 310, and step 320 and step 340 may be simultaneously performed, or step 340 may be performed after step 320.

Specifically, in step 310, the second device sends, to the first device, data used to transmit a service, and the data is carried on time-frequency resources. If it is determined that other service data of a higher priority needs to be transmitted, the other service data of the higher priority may puncture the resources to which the data is mapped, to replace service data on some time-frequency resources with the other service data of the higher priority. After the replacement, data before the replacement is no longer sent on the resources on which data is replaced. The other service data of the higher priority may be from the second device or a device other than the first device and the second device. In addition, puncturing may also include a case in which a service sent by the device other than the first device and the second device causes strong interference to the first device, so that the second device stops sending the data of the service on a corresponding time-frequency resource.

Correspondingly, in step 320, the first device receives the data from the second device, and the data is specifically the service data of the higher priority that replaces service data on some time-frequency resources, and original service data that is still transmitted on other time-frequency resources.

In step 330, the second device sends the indication information to the first device.

Correspondingly, in step 340, the first device receives the indication information from the second device, where the indication information is used by the first device to divide the time-frequency resources into the first time-frequency resource and/or the second time-frequency resource.

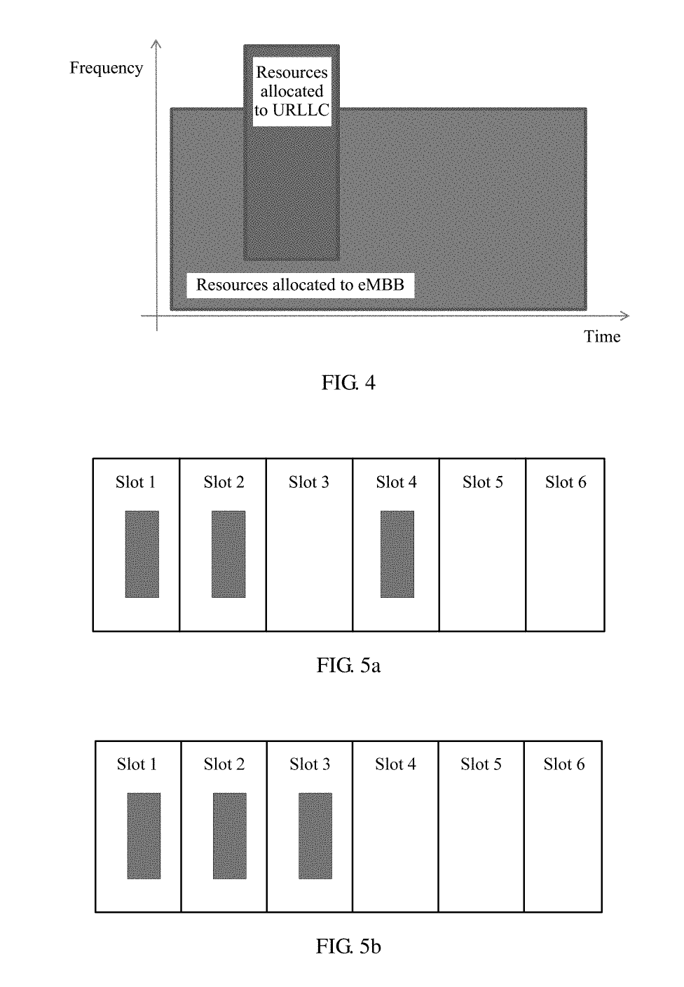

The indication information specifically includes at least one of scheduling unit identification information, CB identification information, and CB group identification information; or location information of a punctured area. When the indication information includes the location information of the punctured area, the first device calculates the first time-frequency resource based on the location information of the punctured area, and a time-frequency resource, in the time-frequency resources, other than the first time-frequency resource is the second time-frequency resource. The first device may determine the first time-frequency resource according to the following rule: When there is an intersection between at least one scheduling unit and the punctured area, the at least one scheduling unit belongs to the first time-frequency resource; or when there is an intersection between a time-frequency resource of at least one CB and the punctured area, the at least one CB belongs to the first time-frequency resource; or when there is an intersection between a time-frequency resource of at least one CB group and the punctured area, the at least one CB group belongs to the first time-frequency resource. The first device determines the first time-frequency resource (there may be a case in which all the time-frequency resources are the first time-frequency resource or all the time-frequency resources are the second time-frequency resource). All or some of service data on the first time-frequency resource is replaced with the service data of the higher priority. The second time-frequency resource is a time-frequency resource, in the time-frequency resources, other than the first time-frequency resource, and the original service data is still transmitted on the second time-frequency resource. The first device receives, from the second device, data that is carried on the first time-frequency resource and the second time-frequency resource. In this embodiment of the present invention, all or some of the service data on the first time-frequency resource may be replaced with the service data of the higher priority before the second device sends the data to the first device, or when the second device sends the data to the first device, or in a process in which the second device sends the data to the first device. The other service data of the higher priority may be from the second device or the device other than the first device and the second device. For example, the service sent by the device other than the first device and the second device causes strong interference to the first device, so that the second device stops sending the data of the service on the corresponding time-frequency resource. The service data with the higher priority may be service data that requires high reliability and a low latency, for example, URLLC service data in a 5G system that has a priority higher than that of eMBB service data. FIG. 4 is a schematic diagram of preempting eMBB data by URLLC data.

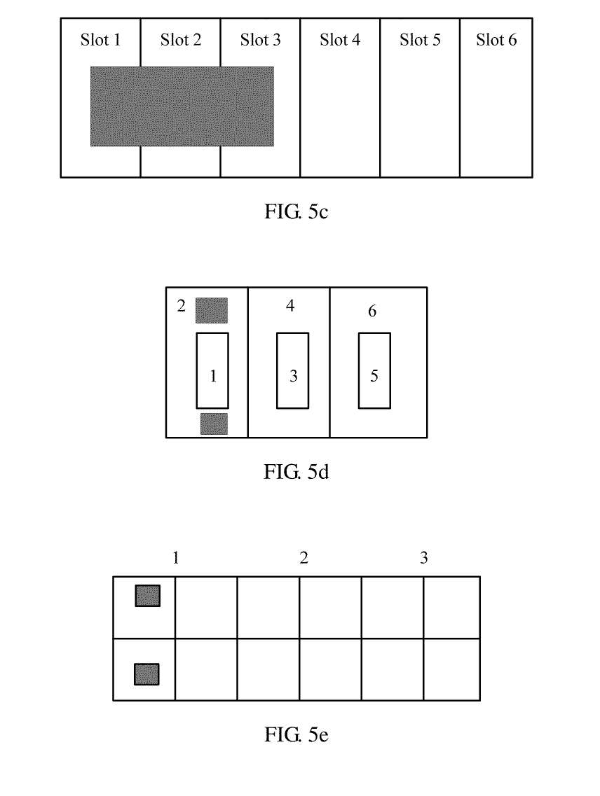

When the rule for determining the first time-frequency resource is that when there is an intersection between at least one scheduling unit and the punctured area, the at least one scheduling unit belongs to the first time-frequency resource, a scheduling unit may be a slot or a mini-slot. FIG. 5a includes six scheduling units, respectively a slot 1, a slot 2, a slot 3, a slot 4, a slot 5, and a slot 6. There is an intersection between the punctured area (shadow area) and each of the slot 1, the slot 2, and the slot 4. In this case, the slot 1, the slot 2, and the slot 4 are determined as the first time-frequency resource, and the remaining slot 3, slot 5, and slot 6 are determined as the second time-frequency resource.

The punctured area may alternatively be in a form shown in FIG. 5b. The punctured area is distributed in the slot 1, the slot 2, and the slot 3 in a discrete form. In this case, the slot 1, the slot 2, and the slot 3 are determined as the first time-frequency resource, and the remaining slot 4, slot 5, and slot 6 are determined as the second time-frequency resource.

The punctured area may alternatively be in a form shown in FIG. 5c. The punctured area is distributed in the slot 1, the slot 2, and the slot 3 in a contiguous block form. In this case, the slot 1, the slot 2, and the slot 3 are determined as the first time-frequency resource, and the remaining slot 4, slot 5, and slot 6 are determined as the second time-frequency resource.

Scheduling units may be in a “hollow square” shape shown in FIG. 5d. A scheduling unit 1 is in a hollow of the “hollow square” shape, and a scheduling unit 2 is outside the hollow of the “hollow square” shape, and there is an intersection between the punctured area and the scheduling unit 2. In this case, the scheduling unit 2 is the first time-frequency resource, and the scheduling unit 1, a scheduling unit 3, a scheduling unit 4, a scheduling unit 5, and a scheduling unit 6 are the second time-frequency resource.

A scheduling unit may be in a “2×2 grid” shape shown in FIG. 5e. A scheduling unit includes a resource block 1, a resource block 2, a resource block 3, and a resource block 4 in a clockwise direction, and there is an intersection between the punctured area and each of the resource block 1 and the resource block 4. In this case, a scheduling unit 1 is the first time-frequency resource, and a scheduling unit 2 and a scheduling unit 3 are the second time-frequency resource.

In step 350, the first device determines a manner of sending, to the second device, the feedback information of the data carried on the first time-frequency resource and/or a manner of sending the feedback information of the data carried on the second time-frequency resource, and sends the feedback information to the second device in a determined manner of sending the feedback information. The feedback information may be determined based on a decoding status. For example, a CB carried on the second time-frequency resource is decoded, and if any CB is incorrectly decoded, for example, if a CRC check error occurs, a CB fails to be decoded, and a negative acknowledgement is fed back, such as a NACK, or otherwise, an acknowledgement is fed back, such as an ACK. In an existing LTE protocol, a TB is finally mapped to a codeword, and the feedback information is determined based on a data decoding status in the codeword. In this application, the first device feeds back only to some data in the codeword based on the indication information. Feedback information in Embodiment 2 to Embodiment 9 is the same as that herein, and details are not described below.

The first device determines three manners of sending the feedback information to the second device:

Manner 1: The first device determines not to send, to the second device, the feedback information of the data carried on the first time-frequency resource.

Manner 2: The first device determines to send, to the second device, feedback information of a first CB in the data carried on the first time-frequency resource, where the first device determines the first CB according to a preset rule, and the first CB is a part or all of the data on the first time-frequency resource.

Manner 3: The first device determines to send, to the second device, the feedback information of the data carried on the second time-frequency resource.

Therefore, the first device may send the feedback information to the second device in the following manners: the manner 1, the manner 2 (all time-frequency resources corresponding to the two manners are the first time-frequency resource), the manner 3 (all corresponding time-frequency resources are the second time-frequency resource), a manner 1+3, and a manner 2+3.

The following uses an example in which the indication information includes the scheduling unit identification information to describe in detail how the first device determines the first time-frequency resource based on the scheduling unit identification information, and processes feedback information in the manner 1+3 and the manner 2+3.

Specifically, when the indication information includes the scheduling unit identification information, the first device determines the first time-frequency resource based on the scheduling unit identification information. The identification information may be a scheduling unit number, or may be other information used to uniquely identify a scheduling unit.

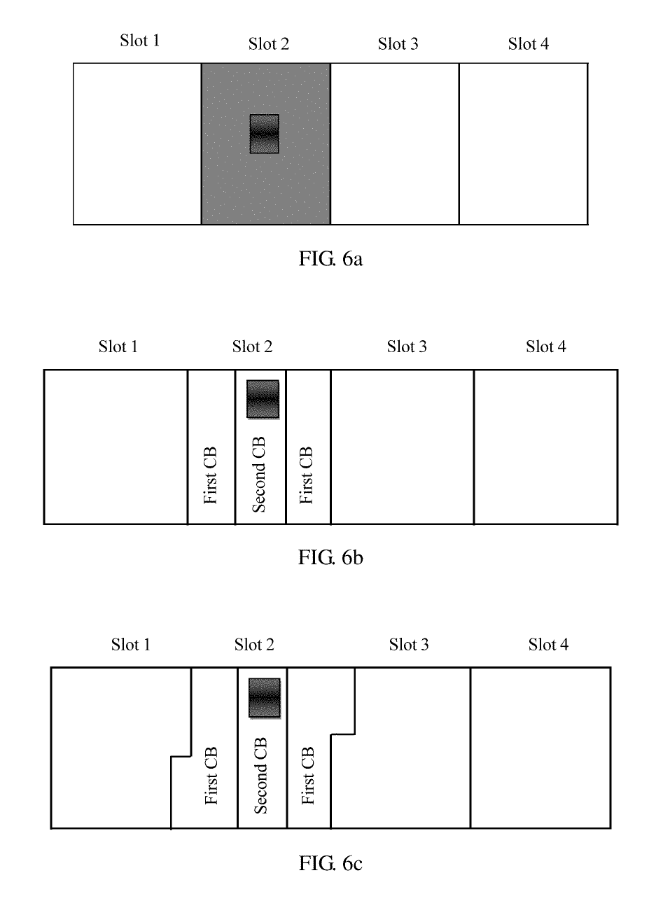

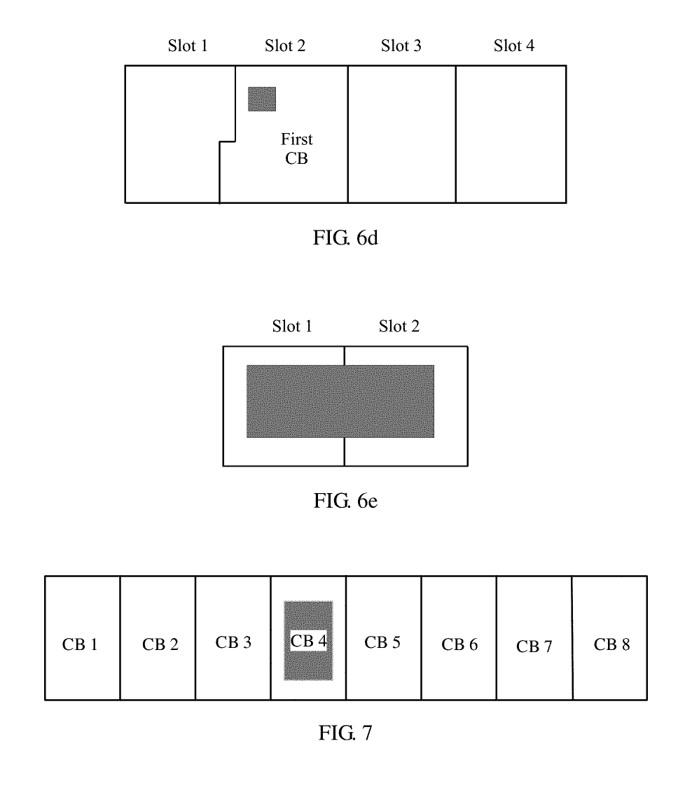

As shown in FIG. 6a, the second device receives the indication information from the first device, and the first device determines a slot 2 as the first time-frequency resource, and a slot 1, a slot 3, and a slot 4 as the second time-frequency resource according to the indication information.

In an implementation, both the first CB and a second CB are located in the slot 2, as shown in FIG. 6b. In this case, the first device sends feedback information of the slot 1, the slot 3, and the slot 4 to the second device, and does not send feedback information of the slot 2. The first device sends the feedback information of the slot 1, the slot 3, and the slot 4 to the second device in two manners.

Manner 1: The first device sends an acknowledgement, such as an ACK, to the second device if all CBs in the slot 1, the slot 3, and the slot 4 are correctly decoded, or the first device sends a negative acknowledgement, such as a NACK, to the second device if one CB in the slot 1, the slot 3, and the slot 4 is incorrectly decoded. The acknowledgement or the negative acknowledgement occupies 1 bit.

Manner 2: For CBs in the slot 1, the slot 3, and the slot 4, the first device sends an acknowledgement, such as an ACK, to the second device for a CB that is correctly decoded, or the first device sends a negative acknowledgement, such as a NACK, to the second device for a CB that is incorrectly decoded. A sum of quantities of acknowledgements and negative acknowledgements is equal to a sum of quantities of CBs in the slot 1, the slot 3, and the slot 4.

In another implementation, the first device determines the first CB according to the preset rule. For example, one part of the first CB is located in the slot 1 and the slot 3 and the other part is located in the slot 2, and a second CB is located in the slot 2, as shown in FIG. 6c. In this case, the first device may send a decoding status of a CB on the second time-frequency resource to the second device, and does not send a decoding status of the first CB. A specific manner of sending feedback information is the same as that in the foregoing implementation, and is not described herein again.

In addition, the first device may send decoding statuses of the first CB and the CB on the second time-frequency resource to the second device. The first device sends an acknowledgement, such as an ACK, to the second device if all the CB on the second time-frequency resource and the first CB are correctly decoded, or the first device sends a negative acknowledgement, such as a NACK, to the second device if at least one of the CB on the second time-frequency resource and the first CB is incorrectly decoded. Alternatively, the first device sends an acknowledgement, such as an ACK, to the second device if the first CB is correctly decoded; the first device sends a negative acknowledgement, such as a NACK, to the second device if the first CB is incorrectly decoded; the first device sends an acknowledgement, such as an ACK, to the second device if the CB on the second time-frequency resource is correctly decoded; or the first device sends a negative acknowledgement, such as a NACK, to the second device if the CB on the second time-frequency resource is incorrectly decoded. Alternatively, the first device sends an acknowledgement to the second device for a CB that is correctly decoded in the CB on the second time-frequency resource and the first CB, or the first device sends a negative acknowledgement to the second device for a CB that is incorrectly decoded in the CB on the second time-frequency resource and the first CB.

In still another implementation, there is only the first CB in the slot 2, one part of the first CB is located in the slot 2, and the other part is located in the slot 1, as shown in FIG. 6d. In this case, the first device may send the feedback information of the first time-frequency resource, to be specific, the slot 1, the slot 3, and the slot 4, to the second device, and does not send the feedback information of the second time-frequency resource, to be specific, the slot 2. In another case, the first device may send the feedback information of the first time-frequency resource and the second time-frequency resource, to be specific, the slot 1, the slot 2, the slot 3, and the slot 4, to the second device. A specific manner of sending the feedback information is the same as that in the foregoing implementation, and is not described herein again.

In yet another implementation, as shown in FIG. 6e, if the slot 1 and the slot 2 are punctured, both the slot 1 and the slot 2 are determined as the first time-frequency resource, and there is no second time-frequency resource. Therefore, the first device does not send the feedback information of the second time-frequency resource. In this case, the first device may send only the feedback information of the first time-frequency resource, to be specific, the slots and the slot 2, to the second device, or the first device may send no feedback information.

In still yet another implementation, if there is only the second time-frequency resource but no first time-frequency resource, the first device sends only the feedback information of the second time-frequency resource to the second device.

### Embodiment 2

In Embodiment 1, a first time-frequency resource is determined based on a scheduling unit, and corresponding processing is performed. Embodiment 2 describes how a first device determines the first time-frequency resource based on a CB and correspondingly sends feedback information.

When the first device receives indication information from a second device, and the indication information includes CB identification information, and when there is an intersection between a time-frequency resource of at least one CB and a punctured area, the at least one CB belongs to the first time-frequency resource.

FIG. 7 is a schematic diagram of puncturing statuses of CBs. Specifically, puncturing statuses of a CB 1, a CB 2, a CB 3, a CB 4, a CB 5, a CB 6, a CB 7, and a CB 8 are shown. The first device determines the CB 4 as the first time-frequency resource, and the CB 1, the CB 2, the CB 3, the CB 5, the CB 6, the CB 7, and the CB 8 as a second time-frequency resource based on the CB identification information in the indication information.

That the first device sends, to the second device, feedback information of data carried on the second time-frequency resource specifically includes: sending, by the first device, a decoding status of a CB on the second time-frequency resource to the second device; and sending, by the first device, an acknowledgement to the second device if all the CB is correctly decoded, or sending, by the first device, a negative acknowledgement to the second device if at least one of the CB is incorrectly decoded; or sending, by the first device, an acknowledgement to the second device for a CB that is correctly decoded, or sending, by the first device, a negative acknowledgement to the second device for a CB that is incorrectly decoded.

In this embodiment, because there are seven CBs on the second time-frequency resource, and an acknowledgement or a negative acknowledgement of each CB corresponds to one ACK or one NACK, feedback information of the seven CBs is n ACKs and (7-n) NACKs, and n is an integer less than 7.

In this embodiment, there is also a case in which there is only the first time-frequency resource but no second time-frequency resource, or there is only the second time-frequency resource but no first time-frequency resource in the foregoing embodiment. In this case, an implementation of the sending, by the first device, the feedback information to the second device is the same as a corresponding implementation in Embodiment 1, and details are not described herein again.

### Embodiment 3

Corresponding processing is performed based on a plurality of CBs included in data in Embodiment 2. In view of a case in which there may be a relatively large quantity of CBs, the embodiments of the present invention further provide Embodiment 3 in which CBs are specifically grouped to obtain a plurality of CB groups and processing is performed based on the CB groups, thereby effectively decreasing processing resources. Further, in Embodiment 3, the CBs are grouped based on a relationship between slots in which a plurality of CBs is located. CBs that are adjacent in slots and use a same subcarrier are grouped into one CB group. In other words, any one of the plurality of CB groups includes at least one CB, and at least one CB included in any CB group intersects in frequency domain and is adjacent in time domain.

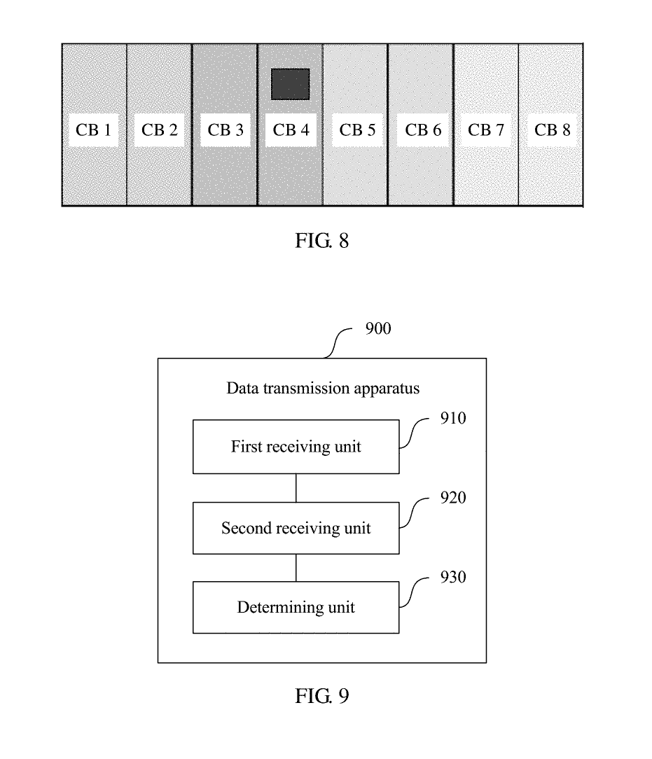

When a first device receives indication information from a second device, and the indication information includes CB group identification information, and when there is an intersection between a time-frequency resource of at least one CB group and a punctured area, the at least one CB group belongs to a first time-frequency resource. For example, referring to FIG. 8, a CB 1 and a CB 2 are in a CB group 1, a CB 3 and a CB 4 are in a CB group 2, a CB 5 and a CB 6 are in a CB group 3, and a CB 7 and a CB 8 are in a CB group 4. Based on the indication information from the second device, the CB 4 in the CB group 2 is partially punctured, and the first device determines that the first time-frequency resource is the CB group 2, and a second time-frequency resource is the CB group 1, the CB group 3, and the CB group 4.

That the first device sends, to the second device, feedback information of data carried on the second time-frequency resource specifically includes: sending, by the first device, a decoding status of a CB group on the second time-frequency resource to the second device; and sending, by the first device, an acknowledgement, such as one ACK, to the second device if all the CB group is correctly decoded, or sending, by the first device, a negative acknowledgement, such as one NACK, to the second device if at least one of the CB group is incorrectly decoded; or

sending, by the first device, a decoding status of a CB group on the second time-frequency resource to the second device; and sending, by the first device, an acknowledgement to the second device for a CB group that is correctly decoded, or sending, by the first device, a negative acknowledgement to the second device for a CB group that is incorrectly decoded. Feedback information of the three CB groups is m ACKs and (3-m) NACKs, and m is an integer less than 3.

In this embodiment, there is also a case in which there is only the first time-frequency resource but no second time-frequency resource, or there is only the second time-frequency resource but no first time-frequency resource, or feedback information of some or all of the first time-frequency resource is sent, and feedback information of the second time-frequency resource is also sent in the foregoing embodiment. In this case, an implementation of the sending, by the first device, the feedback information to the second device is the same as a corresponding implementation in Embodiment 1, and details are not described herein again.

### Embodiment 4

Embodiment 4 describes how a first device determines a first time-frequency resource based on scheduling unit identification information and CB identification information and performs corresponding processing.

When the first device receives indication information from a second device, and the indication information includes the scheduling unit identification information and the CB identification information, the first device first determines, based on the scheduling unit identification information, an overall range of time-frequency resources on which feedback information needs to be sent this time. For example, the indication information includes a slot 1, a slot 2, a slot 3, and a slot 4 (referring to FIG. 6a), and it indicates that feedback information of the four slots needs to be sent. The first device then determines location information of a punctured CB based on the CB identification information, to determine a slot in which a punctured area is located, for example, the slot 2 in which the punctured CB is located, and the first device determines the first time-frequency resource, namely, the slot 2. Finally, the first device does not send feedback information of the first time-frequency resource, and sends feedback information of a second time-frequency resource. A subsequent step of sending, by the first device, the feedback information of the second time-frequency resource to the second device is the same as the step in Embodiment 1, and is not described herein again.

### Embodiment 5

Embodiment 5 describes how a first device determines a first time-frequency resource based on location information of a punctured area and performs corresponding processing.

When the first device receives indication information from a second device, and the indication information includes the location information of the punctured area, the first device may determine the first time-frequency resource based on the location information of the punctured area. For example, a slot 2, a CB 4, or a CB group 2 is determined as the first time-frequency resource. A subsequent step of sending, by the first device, feedback information of a second time-frequency resource to the second device is the same as that in Embodiment 1, Embodiment 2, or Embodiment 3, and is not described herein again.

### Embodiment 6

For the foregoing method procedure, the embodiments of this application further provide a data transmission apparatus. For specific content of the data transmission apparatus, refer to the foregoing method implementations.

FIG. 9 is a schematic structural diagram of a data transmission apparatus according to Embodiment 6 of the present invention. The data transmission apparatus is configured to perform a method procedure performed by the first device. As shown in FIG. 9, the data transmission apparatus 900 includes:

a first receiving unit 910, configured to receive data from a second device, where the data is carried on time-frequency resources;

a second receiving unit 920, configured to receive indication information from the second device, where the indication information is used by the data transmission apparatus to divide the time-frequency resources into a first time-frequency resource and/or a second time-frequency resource; and

a determining unit 930, configured to determine a manner of sending, to the second device, feedback information of data carried on the first time-frequency resource and/or a manner of sending, to the second device, feedback information of data carried on the second time-frequency resource.

Specifically, the indication information includes at least one of scheduling unit identification information, code block CB identification information, and CB group identification information; or location information of a punctured area.

When the indication information is the location information of the punctured area, the data transmission apparatus calculates the first time-frequency resource based on the location information of the punctured area, and a time-frequency resource, in the time-frequency resources, other than the first time-frequency resource is the second time-frequency resource.

When there is an intersection between at least one scheduling unit and the punctured area, the at least one scheduling unit belongs to the first time-frequency resource; or

when there is an intersection between a time-frequency resource of at least one CB and the punctured area, the at least one CB belongs to the first time-frequency resource; or

when there is an intersection between a time-frequency resource of at least one CB group and the punctured area, the at least one CB group belongs to the first time-frequency resource.

Further, the apparatus further includes a sending unit 940, configured to skip sending, to the second device, the feedback information of the data carried on the first time-frequency resource.

The sending unit 940 is configured to send, to the second device, feedback information of a first CB in the data carried on the first time-frequency resource, where the data transmission apparatus determines the first CB according to a preset rule, and the first CB is a part or all of the data on the first time-frequency resource.

The sending unit 940 is configured to send, to the second device, the feedback information of the data carried on the second time-frequency resource.

Further, when not sending, to the second device, the feedback information of the data carried on the first time-frequency resource, and sending, to the second device, the feedback information of the data carried on the second time-frequency resource, the sending unit is specifically configured to: send a decoding status of a CB on the second time-frequency resource to the second device, and send an acknowledgement to the second device if all the CB is correctly decoded, or send a negative acknowledgement to the second device if at least one of the CB is incorrectly decoded; or

send an acknowledgement to the second device for a CB that is correctly decoded, or send a negative acknowledgement to the second device for a CB that is incorrectly decoded.

Further, when not sending, to the second device, the feedback information of the data carried on the first time-frequency resource, and sending, to the second device, the feedback information of the data carried on the second time-frequency resource, the sending unit is specifically configured to: send a decoding status of a CB group on the second time-frequency resource to the second device, and send an acknowledgement to the second device if all the CB group is correctly decoded, or send a negative acknowledgement to the second device if at least one of the CB group is incorrectly decoded; or

send an acknowledgement to the second device for a CB group that is correctly decoded, or send a negative acknowledgement to the second device for a CB group that is incorrectly decoded.

Further, when sending, to the second device, the feedback information of the first CB in the data carried on the first time-frequency resource, and sending, to the second device, the feedback information of the data carried on the second time-frequency resource, the sending unit is specifically configured to: send decoding statuses of a CB on the second time-frequency resource and the first CB to the second device, and send an acknowledgement to the second device if all the CB on the second time-frequency resource and the first CB are correctly decoded, or send a negative acknowledgement to the second device if at least one of the CB on the second time-frequency resource and the first CB is incorrectly decoded; or

send decoding statuses of a CB on the second time-frequency resource and the first CB to the second device, and send an acknowledgement to the second device if the first CB is correctly decoded, send a negative acknowledgement to the second device if the first CB is incorrectly decoded, send an acknowledgement to the second device if all the CB on the second time-frequency resource is correctly decoded, or send a negative acknowledgement to the second device if at least one of the CB on the second time-frequency resource is incorrectly decoded; or

send decoding statuses of a CB on the second time-frequency resource and the first CB to the second device, and send an acknowledgement to the second device for a CB that is correctly decoded in the CB on the second time-frequency resource and the first CB, or send a negative acknowledgement to the second device for a CB that is incorrectly decoded in the CB on the second time-frequency resource and the first CB.

### Embodiment 7

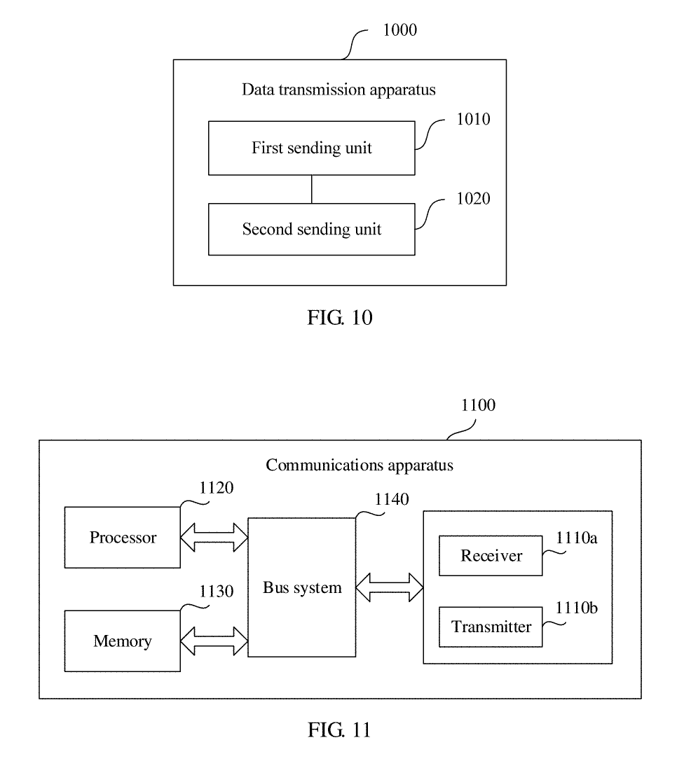

FIG. 10 is a schematic structural diagram of a data transmission apparatus according to Embodiment 7 of the present invention. The data transmission apparatus is configured to perform a method procedure performed by the second device. As shown in FIG. 10, the data transmission apparatus 1000 includes: a first sending unit 1010 and a second sending unit 1020.

The first sending unit 1010 is configured to send data to a first device, where the data is carried on time-frequency resources.

The second sending unit 1020 is configured to send indication information to the first device, where the indication information is used by the first device to divide the time-frequency resources into a first time-frequency resource and/or a second time-frequency resource, and to determine a manner of sending, to the data transmission apparatus, feedback information of data carried on the first time-frequency resource and/or a manner of sending, to the second device, feedback information of data carried on the second time-frequency resource.

The indication information includes at least one of scheduling unit identification information, code block CB identification information, and CB group identification information; or location information of a punctured area.

Specifically, when the indication information is the location information of the punctured area, the first device calculates the first time-frequency resource based on the location information of the punctured area, and a time-frequency resource, in the time-frequency resources, other than the first time-frequency resource is the second time-frequency resource.

When there is an intersection between at least one scheduling unit and the punctured area, the at least one scheduling unit belongs to the first time-frequency resource; or when there is an intersection between a time-frequency resource of at least one CB and the punctured area, the at least one CB belongs to the first time-frequency resource; or when there is an intersection between a time-frequency resource of at least one CB group and the punctured area, the at least one CB group belongs to the first time-frequency resource.

Further, the apparatus further includes a receiving unit 1030, and the receiving unit 1030 is configured to skip receiving, from the first device, the feedback information of the data carried on the first time-frequency resource.

The receiving unit 1030 is configured to receive, from the first device, feedback information of a first CB in the data carried on the first time-frequency resource, where the first device determines the first CB according to a preset rule, and the first CB is a part or all of the data on the first time-frequency resource.

The receiving unit 1030 is configured to receive the feedback information of the data on the second time-frequency resource from the first device.

When not receiving, from the first device, the feedback information of the data carried on the first time-frequency resource, and receiving the feedback information of the data on the second time-frequency resource from the first device, the receiving unit 1030 is specifically configured to: receive a decoding status of a CB on the second time-frequency resource from the first device, where the receiving unit receives an acknowledgement from the first device if all the CB is correctly decoded, or the receiving unit receives a negative acknowledgement from the first device if at least one of the CB is incorrectly decoded; or

receive a decoding status of a CB on the second time-frequency resource from the first device, where the receiving unit receives an acknowledgement from the first device for a CB that is correctly decoded, or the receiving unit receives a negative acknowledgement from the first device for a CB that is incorrectly decoded.

When not receiving, from the first device, the feedback information of the data carried on the first time-frequency resource, and receiving the feedback information of the data on the second time-frequency resource from the first device, the receiving unit 1030 is specifically configured to: receive a decoding status of a CB group on the second time-frequency resource from the first device, and receive an acknowledgement from the first device if all the CB group is correctly decoded, or receive a negative acknowledgement from the first device if at least one of the CB group is incorrectly decoded; or

receive a decoding status of a CB group on the second time-frequency resource from the first device, and receive an acknowledgement from the first device for a CB group that is correctly decoded, or receive a negative acknowledgement from the first device for a CB group that is incorrectly decoded.

When the receiving unit receives, from the first device, the feedback information of the first CB in the data carried on the first time-frequency resource, and receives the feedback information of the data on the second time-frequency resource from the first device, the receiving unit 1030 is specifically configured to: receive decoding statuses of a CB on the second time-frequency resource and the first CB from the first device, and receive an acknowledgement from the first device if all the CB on the second time-frequency resource and the first CB are correctly decoded, or receive a negative acknowledgement from the first device if at least one of the CB on the second time-frequency resource and the first CB is incorrectly decoded; or

receive decoding statuses of a CB on the second time-frequency resource and the first CB from the first device, and receive an acknowledgement from the first device if the first CB is correctly decoded, receive a negative acknowledgement from the first device if the first CB is incorrectly decoded, receive an acknowledgement from the first device if all the CB on the second time-frequency resource is correctly decoded, or receive a negative acknowledgement from the first device if at least one of the CB on the second time-frequency resource is incorrectly decoded; or

receive decoding statuses of a CB on the second time-frequency resource and the first CB from the first device, and receive an acknowledgement from the first device for a CB that is correctly decoded in the CB on the second time-frequency resource and the first CB, or receive a negative acknowledgement from the first device for a CB that is incorrectly decoded in the CB on the second time-frequency resource and the first CB.

### Embodiment 8

FIG. 11 is a schematic structural diagram of a communications apparatus according to Embodiment 8 of the present invention. The communications apparatus may be a terminal or a base station, and is configured to perform a method procedure performed by the first device. As shown in FIG. 11, the device 1100 includes a receiver lima, a transmitter mob, a processor 1120, a memory 1130, and a bus system 1140.

The memory 1130 is configured to store a program. Only one memory is shown in FIG. 11. Certainly, a plurality of memories may be disposed as required. The memory 1130 may be a memory in the processor 1120.

The memory 1130 stores the following elements: an executable module or a data structure, a subset thereof, or an extended set thereof;

operation instructions, including various operation instructions and used to implement various operations; and

operating systems, including various system programs and configured to implement various basic services and process hardware-based tasks.

The processor 1120 controls an operation of the device 1100, and the processor 1120 may alternatively be referred to as a CPU (central processing unit). In a specific application, all components of the device 1100 are coupled together by using the bus system 114o, and the bus system 1140 may further include a power supply bus, a control bus, a status signal bus, and the like in addition to a data bus. However, for clear description, various types of buses in the figure are marked as the bus system 1140. For ease of illustration, FIG. 11 shows merely an example of the bus system 1140.

The methods disclosed in the embodiments of this application may be applied to the processor 1120, or may be implemented by the processor 1120. The processor 1120 may be an integrated circuit chip and has a signal processing capability. In an implementation process, steps in the foregoing methods can be implemented by using a hardware integrated logical circuit in the processor 1120, or by using instructions in a form of software. The processor 1120 may be a general purpose processor, a digital signal processor (DSP), an application-specific integrated circuit (ASIC), a field programmable gate array (FPGA) or another programmable logic device, a discrete gate or a transistor logic device, or a discrete hardware component. The processor 1120 may implement or perform the methods, the steps, and logical block diagrams that are disclosed in the embodiments of this application. The general purpose processor may be a microprocessor, or the processor may be any conventional processor or the like. Steps of the methods disclosed with reference to the embodiments of this application may be directly executed and accomplished by a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory 1130. The processor 1120 reads information from the memory 1130, and performs the following steps in combination with hardware of the processor 1120.

The receiver 1110a is configured to receive data from a second device, where the data is carried on time-frequency resources.

The receiver 1110a is further configured to receive indication information from the second device, where the indication information is used by the data transmission apparatus to divide the time-frequency resources into a first time-frequency resource and/or a second time-frequency resource, and the processor 1120 is configured to determine a manner of sending, to the second device, feedback information of data carried on the first time-frequency resource and/or a manner of sending, to the second device, feedback information of data carried on the second time-frequency resource.

Further, the indication information includes at least one of scheduling unit identification information, code block CB identification information, and CB group identification information; or location information of a punctured area.

Further, when the indication information is the location information of the punctured area, the communications apparatus calculates the first time-frequency resource based on the location information of the punctured area, and a time-frequency resource, in the time-frequency resources, other than the first time-frequency resource is the second time-frequency resource.

Further, when there is an intersection between at least one scheduling unit and the punctured area, the at least one scheduling unit belongs to the first time-frequency resource; or when there is an intersection between a time-frequency resource of at least one CB and the punctured area, the at least one CB belongs to the first time-frequency resource; or when there is an intersection between a time-frequency resource of at least one CB group and the punctured area, the at least one CB group belongs to the first time-frequency resource.

Further, the transmitter 1110b is specifically configured to skip sending, to the second device, the feedback information of the data carried on the first time-frequency resource.

The transmitter mob is specifically configured to send, to the second device, feedback information of a first CB in the data carried on the first time-frequency resource, where the communications apparatus determines the first CB according to a preset rule, and the first CB is a part or all of the data on the first time-frequency resource.

The transmitter mob is specifically configured to send, to the second device, the feedback information of the data carried on the second time-frequency resource.

Further, when not sending, to the second device, the feedback information of the data carried on the first time-frequency resource, and sending, to the second device, the feedback information of the data carried on the second time-frequency resource, the transmitter mob is specifically configured to: send a decoding status of a CB on the second time-frequency resource to the second device, and send an acknowledgement to the second device if all the CB is correctly decoded, or send a negative acknowledgement to the second device if at least one of the CB is incorrectly decoded; or

send an acknowledgement to the second device for a CB that is correctly decoded, or send a negative acknowledgement to the second device for a CB that is incorrectly decoded.

Further, when not sending, to the second device, the feedback information of the data carried on the first time-frequency resource, and sending, to the second device, the feedback information of the data carried on the second time-frequency resource, the transmitter mob is specifically configured to: send a decoding status of a CB group on the second time-frequency resource to the second device, and send an acknowledgement to the second device if all the CB group is correctly decoded, or send a negative acknowledgement to the second device if at least one of the CB group is incorrectly decoded; or

send an acknowledgement to the second device for a CB group that is correctly decoded, or send a negative acknowledgement to the second device for a CB group that is incorrectly decoded.

Further, when sending, to the second device, the feedback information of the first CB in the data carried on the first time-frequency resource, and sending, to the second device, the feedback information of the data carried on the second time-frequency resource, the transmitter mob is specifically configured to: send decoding statuses of a CB on the second time-frequency resource and the first CB to the second device, and send an acknowledgement to the second device if all the CB on the second time-frequency resource and the first CB are correctly decoded, or send a negative acknowledgement to the second device if at least one of the CB on the second time-frequency resource and the first CB is incorrectly decoded; or

send an acknowledgement to the second device if the first CB is correctly decoded, send a negative acknowledgement to the second device if the first CB is incorrectly decoded, send an acknowledgement to the second device if all the CB on the second time-frequency resource is correctly decoded, or send a negative acknowledgement to the second device if at least one of the CB on the second time-frequency resource is incorrectly decoded; or

send an acknowledgement to the second device for a CB that is correctly decoded in the CB on the second time-frequency resource and the first CB, or send a negative acknowledgement to the second device for a CB that is incorrectly decoded in the CB on the second time-frequency resource and the first CB.

### Embodiment 9

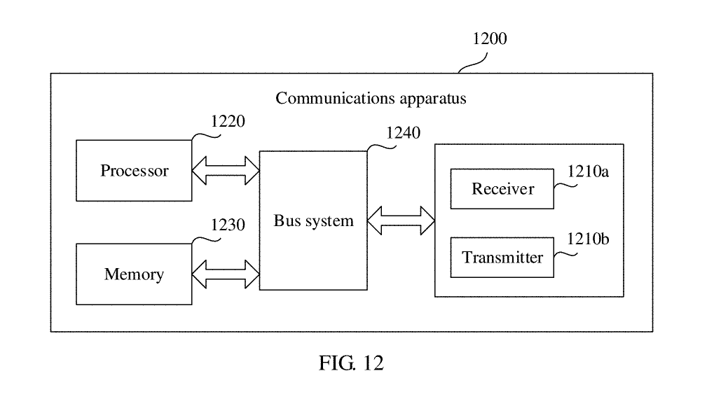

FIG. 12 is a schematic structural diagram of a communications apparatus according to Embodiment 9 of the present invention. The communications apparatus may be a terminal or a base station, and is configured to perform a method procedure performed by the second device. As shown in FIG. 12, the device 1200 includes a transmitter 1210a, a receiver 1210b, a processor 1220, a memory 1230, and a bus system 1240.

The memory 1230 is configured to store a program. Only one memory is shown in FIG. 12. Certainly, a plurality of memories may be disposed as required. The memory 1230 may be a memory in the processor 1220.

The memory 1230 stores the following elements: an executable module or a data structure, a subset thereof, or an extended set thereof;

operation instructions, including various operation instructions and used to implement various operations; and

operating systems, including various system programs and configured to implement various basic services and process hardware-based tasks.

The processor 1220 controls an operation of the terminal 1200, and the processor 1220 may alternatively be referred to as a CPU. In specific application, all components of the terminal 1200 are coupled together by using the bus system 1240, and the bus system 1240 may further include a power supply bus, a control bus, a status signal bus, and the like in addition to a data bus. However, for clear description, various types of buses in the figure are marked as the bus system 1240. For ease of illustration, FIG. 12 shows merely an example of the bus system 1240.

The methods disclosed in the embodiments of this application may be applied to the processor 1220, or may be implemented by the processor 1220. The processor 1220 may be an integrated circuit chip and has a signal processing capability. In an implementation process, steps in the foregoing methods can be implemented by using a hardware integrated logical circuit in the processor 1220, or by using instructions in a form of software. The processor 1220 may be a general purpose processor, a DSP, an ASIC, an FPGA or another programmable logic device, a discrete gate or transistor logic device, or a discrete hardware component. The processor 1220 may implement or perform the methods, the steps, and logical block diagrams that are disclosed in the embodiments of this application. The general purpose processor may be a microprocessor, or the processor may be any conventional processor or the like. Steps of the methods disclosed with reference to the embodiments of this application may be directly executed and accomplished by a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory 1230. The processor 1220 reads information from the memory 1230, and performs the following steps in combination with hardware of the processor 1120.

The transmitter 1210a is configured to send data to a first device, where the data is carried on time-frequency resources.

The transmitter 1210a is further configured to send indication information to the first device, where the indication information is used by the first device to divide the time-frequency resources into a first time-frequency resource and/or a second time-frequency resource, and to determine a manner of sending, to the data transmission apparatus, feedback information of data carried on the first time-frequency resource and/or a manner of sending, to the second device, feedback information of data carried on the second time-frequency resource.

Further, the indication information includes at least one of scheduling unit identification information, code block CB identification information, and CB group identification information; or location information of a punctured area.

When the indication information is the location information of the punctured area, the first device calculates the first time-frequency resource based on the location information of the punctured area, and a time-frequency resource, in the time-frequency resources, other than the first time-frequency resource is the second time-frequency resource.

When there is an intersection between at least one scheduling unit and the punctured area, the at least one scheduling unit belongs to the first time-frequency resource; or

when there is an intersection between a time-frequency resource of at least one CB and the punctured area, the at least one CB belongs to the first time-frequency resource; or

when there is an intersection between a time-frequency resource of at least one CB group and the punctured area, the at least one CB group belongs to the first time-frequency resource.

The receiver 1210b does not receive, from the first device, the feedback information of the data carried on the first time-frequency resource.

The receiver 1210b receives, from the first device, feedback information of a first CB in the data carried on the first time-frequency resource, where the first device determines the first CB according to a preset rule, and the first CB is a part or all of the data on the first time-frequency resource.

The receiver 1210b receives the feedback information of the data on the second time-frequency resource from the first device.

When not receiving, from the first device, the feedback information of the data carried on the first time-frequency resource, and receiving the feedback information of the data on the second time-frequency resource from the first device, the receiver 1210b is specifically configured to: receive a decoding status of a CB on the second time-frequency resource from the first device, and receive an acknowledgement from the first device if all the CB is correctly decoded, or receive a negative acknowledgement from the first device if at least one of the CB is incorrectly decoded; or receive a decoding status of a CB on the second time-frequency resource from the first device, and receive an acknowledgement from the first device for a CB that is correctly decoded, or receive a negative acknowledgement from the first device for a CB that is incorrectly decoded.

When not receiving, from the first device, the feedback information of the data carried on the first time-frequency resource, and receiving the feedback information of the data on the second time-frequency resource from the first device, the receiver 1210b is specifically configured to: receive a decoding status of a CB group on the second time-frequency resource from the first device, and receive an acknowledgement from the first device if all the CB group is correctly decoded, or receive a negative acknowledgement from the first device if at least one of the CB group is incorrectly decoded; or

receive a decoding status of a CB group on the second time-frequency resource from the first device, and receive an acknowledgement from the first device for a CB group that is correctly decoded, or receive a negative acknowledgement from the first device for a CB group that is incorrectly decoded.

When receiving, from the first device, the feedback information of the first CB in the data carried on the first time-frequency resource, and receiving the feedback information of the data on the second time-frequency resource from the first device, the receiver 1210b is specifically configured to: receive decoding statuses of a CB on the second time-frequency resource and the first CB from the first device, and receive an acknowledgement from the first device if all the CB on the second time-frequency resource and the first CB are correctly decoded, or receive a negative acknowledgement from the first device if at least one of the CB on the second time-frequency resource and the first CB is incorrectly decoded; or

receive decoding statuses of a CB on the second time-frequency resource and the first CB from the first device, and receive an acknowledgement from the first device if the first CB is correctly decoded, receive a negative acknowledgement from the first device if the first CB is incorrectly decoded, receive an acknowledgement from the first device if all the CB on the second time-frequency resource is correctly decoded, or receive a negative acknowledgement from the first device if at least one of the CB on the second time-frequency resource is incorrectly decoded; or

receive decoding statuses of a CB on the second time-frequency resource and the first CB from the first device, and receive an acknowledgement from the first device for a CB that is correctly decoded in the CB on the second time-frequency resource and the first CB, or receive a negative acknowledgement from the first device for a CB that is incorrectly decoded in the CB on the second time-frequency resource and the first CB.

The method steps in the embodiments of this application may be implemented in a hardware form, or may be implemented by a processor by executing a software instruction. The software instruction may include a corresponding software module. The software module may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium known in the art. For example, a storage medium is coupled to a processor, so that the processor can read information from the storage medium or write information into the storage medium. Certainly, the storage medium may be a component of the processor. The processor and the storage medium may be located in an ASIC. In addition, the ASIC may be located in a sending device or a receiving device. Certainly, the processor and the storage medium may exist in the sending device or the receiving device as discrete components.

All or some of the foregoing embodiments may be implemented by software, hardware, firmware, or any combination thereof. When software is used to implement the embodiments, the embodiments may be implemented all or partially in a form of a computer program product. The computer program product includes one or more computer instructions. When the computer program instructions are loaded and executed on the computer, the procedure or functions according to the embodiments of the present invention are all or partially generated. The computer may be a general-purpose computer, a dedicated computer, a computer network, or other programmable apparatuses. The computer instruction may be stored in a computer-readable storage medium, or transmitted by using the computer-readable storage medium. The computer instruction may be transmitted from one website, computer, server, or data center to another website, computer, server, or data center in a wired (for example, a coaxial cable, a fiber, or a digital subscriber line (DSL)) or wireless (for example, infrared, wireless, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, DVD), a semiconductor medium (for example, a solid state disk (SSD)), or the like.

It may be understood that various numbers in the embodiments of this application are merely for differentiation for ease of description, but are not used to limit the scope of the embodiments of this application.

It should be understood that sequence numbers of the foregoing processes do not mean execution sequences in the embodiments of this application. The execution sequences of the processes should be determined according to functions and internal logic of the processes, and should not be construed as any limitation on the implementation processes of the embodiments of this application.

The foregoing descriptions are merely specific implementations of the embodiments of this application, but are not intended to limit this application. Any variation or replacement readily figured out by a person skilled in the art within the technical scope disclosed in this application shall fall within the protection scope of this application.

What is claimed is:

1. A data transmission method, the method comprising:
receiving, by a first device, data from a second device, wherein the data is carried on time-frequency resources;
receiving, by the first device, indication information from the second device so that the first device is able to divide the time-frequency resources into a first time-frequency resource and/or a second time-frequency resource; and
determining, by the first device, a manner of sending feedback information of data carried on the first time-frequency resource to the second device and/or a manner of sending feedback information of data carried on the second time-frequency resource to the second device.

2. The method according to claim 1, wherein the indication information comprises at least one of scheduling unit identification information, code block (CB) identification information and CB group identification information, or location information of a punctured area.

3. The method according to claim 2, wherein the first device calculates the first time-frequency resource based on the location information of the punctured area, and wherein a time-frequency resource other than the first time-frequency resource is the second time-frequency resource.

4. The method according to claim 3,
wherein at least one scheduling unit belongs to the first time-frequency resource when an intersection between the at least one scheduling unit and the punctured area occurs, or
wherein at least one CB belongs to the first time-frequency resource when an intersection between a time-frequency resource of the at least one CB and the punctured area occurs, or
wherein at least one CB group belongs to the first time-frequency resource when an intersection between a time-frequency resource of the at least one CB group and the punctured area occurs.

5. The method according to claim 1, further comprising skipping, by the first device, sending the feedback information of the data carried on the first time-frequency resource to the second device.

6. The method according to claim 1, further comprising sending, by the first device, feedback information of a first CB in the data carried on the first time-frequency resource to the second device, wherein the first device determines the first CB according to a preset rule, and wherein the first CB is a part or all of the data on the first time-frequency resource.

7. The method according to claim 1, further comprising sending, by the first device, the feedback information of the data carried on the second time-frequency resource to the second device.

8. The method according to claim 1, further comprising:
sending, by the first device, the feedback information of the data carried on the second time-frequency resource to the second device when the first device does not send the feedback information of the data carried on the first time-frequency resource to the second device, wherein sending the feedback information comprises sending a decoding status of a CB on the second time-frequency resource to the second device and sending an acknowledgement to the second device when all CBs are correctly decoded, or sending a negative acknowledgement to the second device when at least one of the CBs is incorrectly decoded; or
sending a decoding status of a CB on the second time-frequency resource to the second device and sending an acknowledgement to the second device for a CB that is correctly decoded, or sending a negative acknowledgement to the second device for a CB that is incorrectly decoded.

9. The method according to claim 1, further comprising:
sending a decoding status of a CB group to the second device on the second time-frequency resource when the first device does not send the feedback information of the data carried on the first time-frequency resource to the second device and sending an acknowledgement to the second device when all CB groups are correctly decoded, or sending a negative acknowledgement to the second device when at least one of the CB groups is incorrectly decoded; or
sending a decoding status of a CB group on the second time-frequency resource to the second device and sending an acknowledgement to the second device for a CB group that is correctly decoded, or sending a negative acknowledgement to the second device for a CB group that is incorrectly decoded.

10. The method according to claim 1, further comprising:
sending, to the second device, the feedback information of the data carried on the second time-frequency resource when sending the feedback information of a first CB in the data carried on the first time-frequency resource to the second device, wherein sending feedback information comprises sending decoding statuses of a CB on the second time-frequency resource and the first CB to the second device and sending an acknowledgement to the second device when all CBs on the second time-frequency resource and the first CB are correctly decoded, or sending a negative acknowledgement to the second device when at least one of the CBs on the second time-frequency resource or the first CB is incorrectly decoded; or
sending decoding statuses of a CB on the second time-frequency resource and the first CB to the second device and sending an acknowledgement to the second device when the first CB is correctly decoded, or sending a negative acknowledgement to the second device when the first CB is incorrectly decoded, or sending an acknowledgement to the second device when all CBs on the second time-frequency resource are correctly decoded, or sending a negative acknowledgement to the second device when at least one of the CB on the second time-frequency resource is incorrectly decoded; or
sending decoding statuses of a CB on the second time-frequency resource and the first CB to the second device, and sending an acknowledgement to the second device for a CB that is correctly decoded in the CB on the second time-frequency resource and the first CB, or sending a negative acknowledgement to the second device for a CB that is incorrectly decoded in the CB on the second time-frequency resource and the first CB.

11. A first device comprising:
a processor; and
a non-transitory memory storing programming for execution by the processor, the programming including instructions for:
receiving data from a second device, wherein the data is carried on time-frequency resources;
receiving indication information from the second device;
dividing the time-frequency resources into a first time-frequency resource and/or a second time-frequency resource according to the indication information; and
determining a manner of sending feedback information of data carried on the first time-frequency resource and/or a manner of sending feedback information of data carried on the second time-frequency resource to the second device.

12. The first device according to claim 11, wherein the indication information comprises at least one of scheduling unit identification information, code block CB identification information, and CB group identification information, or location information of a punctured area.

13. The first device according to claim 12, further comprising instructions for calculating the first time-frequency resource based on the location information of the punctured area, a time-frequency resource being another than the first time-frequency resource, wherein the other time-frequency resource is the second time-frequency resource.

14. The first device according to claim 13,
wherein at least one scheduling unit belongs to the first time-frequency resource when an intersection between the at least one scheduling unit and the punctured area occurs, or
wherein at least one CB belongs to the first time-frequency resource when an intersection between a time-frequency resource of the at least one CB and the punctured area occurs, or
wherein at least one CB group belongs to the first time-frequency resource when an intersection between a time-frequency resource of the at least one CB group and the punctured area.

15. The first device according to claim 11, further comprising instruction for skipping sending the feedback information of the data carried on the first time-frequency resource to the second device.

16. The first device according to claim 11, further comprising instructions for sending feedback information of a first CB in the data carried on the first time-frequency resource to the second device, wherein the first CB is determined according to a preset rule, and the first CB is a part or all of the data on the first time-frequency resource.

17. The first device according to claim 11, further comprising instructions for sending the feedback information of the data carried on the second time-frequency resource to the second device.

18. The first device according to claim 11, further comprising instructions for:
sending the feedback information of the data carried on the second time-frequency resource to the second device when not sending the feedback information of the data carried on the first time-frequency resource to the second device, wherein sending the feedback information comprises sending a decoding status of a CB on the second time-frequency resource to the second device and sending an acknowledgement to the second device when all CBs are correctly decoded, or sending a negative acknowledgement to the second device when at least one of the CBs is incorrectly decoded; or
sending a decoding status of a CB on the second time-frequency resource to the second device and sending an acknowledgement to the second device for a CB that is correctly decoded, or sending a negative acknowledgement to the second device for a CB that is incorrectly decoded.

19. The first device according to claim 11, further comprising instructions for: sending a decoding status of a CB group to the second device on the second time-frequency resource when the first device does not send the feedback information of the data carried on the first time-frequency resource to the second device and sending an acknowledgement to the second device when all CB groups are correctly decoded, or sending a negative acknowledgement to the second device when at least one of the CB groups is incorrectly decoded; or
sending a decoding status of a CB group on the second time-frequency resource to the second device and sending an acknowledgement to the second device for a CB group that is correctly decoded, or sending a negative acknowledgement to the second device for a CB group that is incorrectly decoded.

20. The first device according to claim 11, further comprising instructions for:
sending the feedback information of the data carried on the second time-frequency resource to the second device when sending the feedback information of a first CB in the data carried on the first time-frequency resource to the second device, wherein sending the feedback information comprises sending decoding statuses of a CB on the second time-frequency resource and the first CB to the second device, and sending an acknowledgement to the second device when all CBs on the second time-frequency resource and the first CB are correctly decoded, or sending a negative acknowledgement to the second device when at least one of the CBs on the second time-frequency resource and the first CB is incorrectly decoded; or
sending decoding statuses of a CB on the second time-frequency resource and the first CB to the second device, sending an acknowledgement to the second device when the first CB is correctly decoded, or sending a negative acknowledgement to the second device when the first CB is incorrectly decoded, or sending an acknowledgement to the second device when all the CBs on the second time-frequency resource are correctly decoded, or sending a negative acknowledgement to the second device when at least one of the CB on the second time-frequency resource is incorrectly decoded; or
sending decoding statuses of a CB on the second time-frequency resource and the first CB to the second device, and sending an acknowledgement to the second device for a CB that is correctly decoded in the CB on the second time-frequency resource and the first CB, or sending a negative acknowledgement to the second device for a CB that is incorrectly decoded in the CB on the second time-frequency resource and the first CB.
